(19) United States
(12) Patent Application Publication
(10) Pub. No.: US 2012/0032005 A1
(43) Pub. Date: Feb. 9, 2012

(54) AGRICULTURE DISTRIBUTION SYSTEM

(75) Inventors: Randy M. McMahon, Lakeville, MN (US); Frank D. Bazzoli, St. James, MN (US); Donald R. Marcy, Bingham Lake, MN (US); Ronald J. Veenker, Bingham Lake, MN (US)

(73) Assignee: BALZER, INC., Mountain Lake, MN (US)

(21) Appl. No.: 12/850,761

(22) Filed: Aug. 5, 2010

(51) Int. Cl. B05B 3/18

(52) U.S. Cl. 239/722

(57) ABSTRACT

The present invention provides a versatile agriculture applicator system which enables relatively large agricultural field application systems to both be moved over roadways and to address fields using a wide swath application. The applicator system of the invention includes a unique support carriage arrangement which is supported by orthogonally disposed sets of support wheels including selectively deployable wheels that enable the carriage to move optionally parallel to the length or width of the chassis.

### CROSS-REFERENCED TO RELATED APPLICATIONS

Cross references is made to application Ser. No. ______, filed of even date and entitled “DISTRIBUTION SYSTEM FOR LIQUID MANURE SPREADER”, which is assigned to the same Assignee as the present application. That application is deemed incorporated herein in its entirety for any purpose.

### STATEMENT REGARDING FEDERALLY SPONSORED RESEARCH OR DEVELOPMENT

Not applicable

### BACKGROUND OF THE INVENTION

I. Field of the Invention

The present invention relates generally to agricultural implements and, more particularly, to an agricultural application system which provides an increased load-carrying capacity with reduced soil compaction. Specifically, the present invention relates to a carriage system for a distribution system for liquid manure slurry or other material that enables an increased working width in fields, but which retains a narrow transport width for hauling over the road.

II. Related Art

Agricultural material distribution systems for spreading materials or performing other operations throughout large agricultural fields are becoming larger and more sophisticated. Such systems are used to seed and spray crops and to apply various types of dry and wet fertilizer material.

Typical of such systems are liquid manure spreading systems used in the transportation and application of liquid manure which is obtained generally from manure, ponds or lagoons associated with the keeping of farm livestock. The material is generally taken from the lagoon and recycled to agricultural fields. This is accomplished typically by pumping the material out of the lagoon into large tanks mounted on carriages with oversized wheels for field distribution of the slurry.

Liquid manure application systems generally include one or more large tanks mounted on a chassis designed to be towed by a tractor. The tanks may be of rather large capacity, normally several thousand gallons, and are connected through multiple hoses to a plurality of spaced outlets which distribute the liquid manure into the ground, typically using soil injection tools. The liquid manure is usually pumped from the tanks into a central distribution manifold, which has a number of outlet openings. These openings, in turn, are connected by the hoses to the soil injection tools, or the like, located at spaced intervals which can vary according to the distances between crop rows.

As indicated, these liquid manure application machines over the course of time have evolved into very large capacity units in which a plurality of large storage tanks, each holding thousands of gallons of material, are carried on elongated chassis having multiple spaced axles to meet road weight limit allowances, some units having up to four axles. This requires the units to be quite long and therefore, difficult to maneuver. In addition, the added weight of these large units has required the use of very wide tires in order to reduce the soil compaction factor.

While these earlier units have been somewhat successful, currently used systems do suffer from several significant limitations. Even when properly placed, the wide tires often interfere with current or future crop row placement. In addition, the soil incorporator or injection tools are normally located at the rear of the trailer unit, far from the operator, so that it is difficult for an operator to observe the injection operation. In addition, the number of individual incorporators is limited by the transport width of the applicator which must meet roadway limitations.

### SUMMARY OF THE INVENTION

The present invention provides a versatile agriculture applicator system which enables relatively large agricultural field application systems to both be moved over roadways and to address fields using a wide swath application. The invention is particularly directed to a unique support carriage arrangement which features orthogonally disposed sets of support wheels including selectively deployable wheels that enable the carriage to move optionally parallel to the length or width of the chassis.

The chassis may further include a pair of opposed spaced chassis frame units pivotally attached to a center frame unit, each chassis frame unit further being mounted on a plurality of equally spaced, parallel, lateral support wheels disposed along the length thereof and parallel to the width thereof for providing low soil compaction support and carrying said applicator across a field parallel to the width thereof; and wherein the carriage also has a pair of lateral axles carrying wheels to optionally support the carriage for moving it in said lengthwise direction for movement over roadways to places of application. These lateral axles are deployable/retractable tag-type axles.

Hitch devices are attached to the carriage such that the applicator can be moved by a tractor both in a lengthwise direction for transporting to a place of application and in a lateral direction parallel to the width thereof for application operations.

One preferred embodiment is dedicated to the distribution of liquid manure material and includes a tank mounted on each chassis frame unit, each tank being in fluid communication with a fluid distribution system; a plurality of incorporation tools spaced along the length of each chassis frame unit and directed generally at right angles thereto, the incorporation tools being connected to receive and apply liquid manure from the tanks through the distribution system.

It will be appreciated that the number size and spacing of the wheels can vary depending on allowable spacing and the weight of the application system. Low soil compaction is an important factor. In certain embodiments, multiple rows of lateral support wheels may be used. Axle spacing and the number of axles for carriage support over the road must comply with the applicable axle spacing and load limit regulations.

The ability to treat fields with an applicator having a relatively wide swath also gives the operator on the pulling vehicle, normally a farm tractor, a much improved, closer view of the application process.

The applicator further generally includes a toolbar that carries a plurality of spaced soil treatment devices such as plows, disks and injector tools. It will be appreciated that the toolbar can be raised to a position that reduces the overall width of the applicator for moving the system over a roadway or the like. These devices may take many forms, as will occur to those skilled in the art.

### BRIEF DESCRIPTION OF THE DRAWINGS

In the drawings wherein like reference characters denote like parts:

FIG. 1A is a perspective view of a dual slurry tank liquid manure applicator system including a support carriage arrangement in accordance with the present invention;

FIGS. 1B and 1C are side elevational and end elevational views, respectively, showing an embodiment similar to that of FIG. 1A with the toolbar raised for storage or highway travel;

FIGS. 2A and 2B are reduced side elevational and end elevational views of the embodiment of FIG. 1 showing a towing tractor;

FIG. 2C is a side view of a prior art system;

FIGS. 3A and 3B are top and side views of the embodiment of FIG. 1 with the chassis frame units shown in parallel and the tanks and toolbar removed for clarity;

FIGS. 3C and 3D are sectional views along lines C-C and D-D, respectively in FIG. 3A;

FIG. 3E is a side view of the applicator system of FIGS. 3A and 3B with the tanks and toolbar removed and illustrating the pivotal arrangement of the chassis frame units;

FIG. 4 is a perspective view of a carriage assembly in accordance with the present invention

FIG. 5 is an applicator system in accordance with the invention for the incorporation of anhydrous ammonia;

FIG. 6 is an applicator system in accordance with the invention for a seed and planter system;

FIG. 7 is an applicator system in accordance with the invention for a wide pattern sprayer;

FIG. 8 is an applicator system in accordance with the invention for a dry fertilizer spreader;

FIG. 9 is an applicator system in accordance with the invention for a seed tank and seeder system; and

FIG. 10 is an applicator system in accordance with the invention showing multiple rows of support wheels.

### DETAILED DESCRIPTION

The present invention provides a carriage support arrangement for agriculture applicator systems which enables relatively large agricultural field application systems to both be moved over roadways and to address fields using a wide swath application. The carriage support arrangement is characterized by orthogonally disposed sets of support wheels including selectively deployable wheels that enable the carriage to move optionally parallel to the length or width of the chassis. Embodiments described herein are introduced as examples of the concepts of the invention and are not intended to limit the scope in any manner as variations within these concepts may occur those skilled in the art.

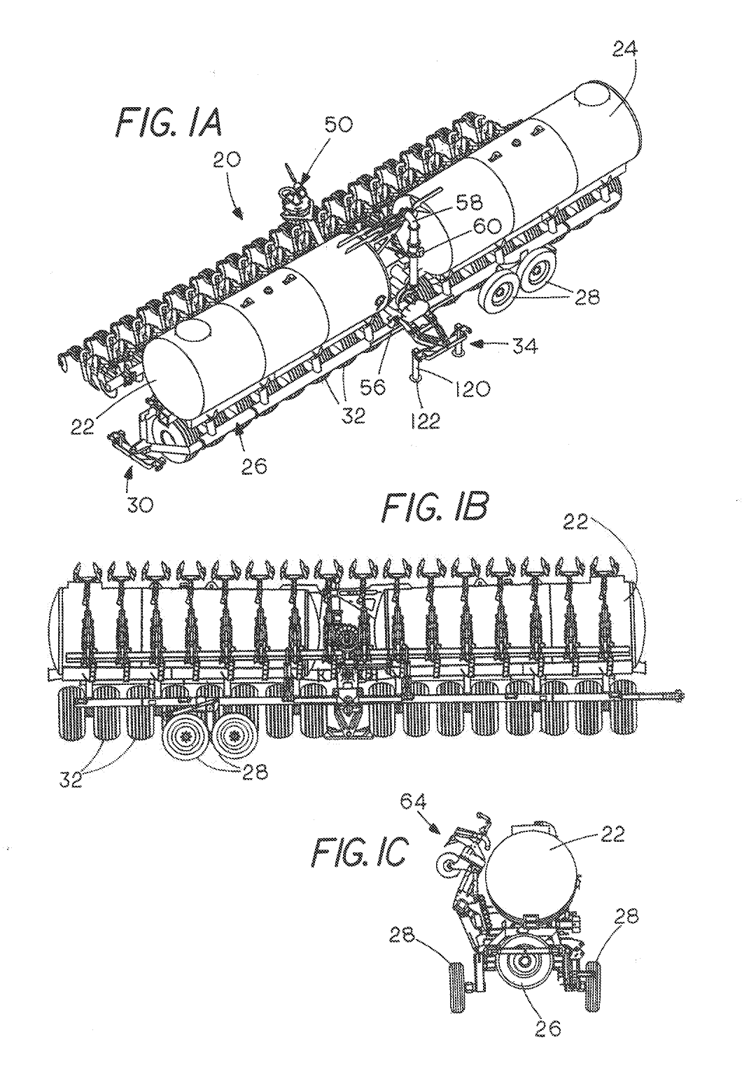

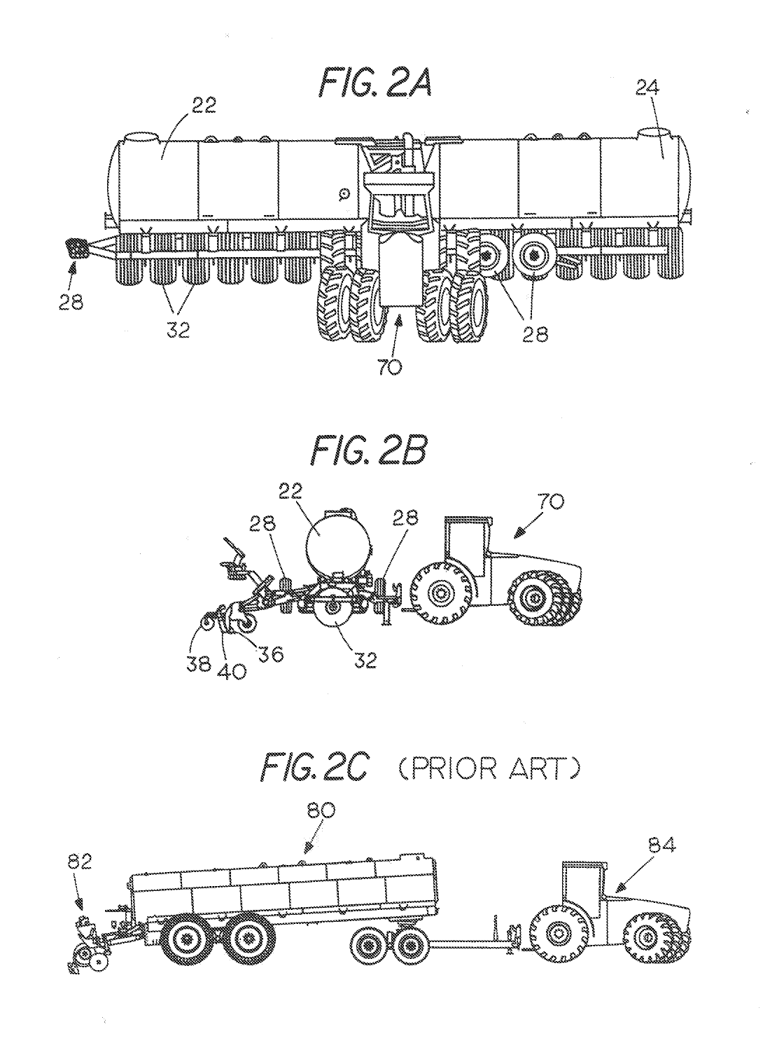

In the drawings, FIG. 1 shows a perspective view of a slurry tank manure spreading system incorporating a carriage construction in accordance with the present invention. The system, generally at 20, includes a pair of large spaced slurry tanks 22 and 24 mounted on a heavy metal chassis 26 which includes orthogonally situated sets of support wheels and hitches, discussed in greater detail below. The support wheels include a selectively deployable highway set, two of which are shown at 28 with highway hitching arrangement 30 for transporting the system on roadways such as, for example, from work site to work site in an unloaded condition. Orthogonally-mounted parallel-spaced lateral support wheels as at 32 are located along the length of the chassis 26 and a second hitching arrangement is shown at 34 for hitching the system to a tractor (see FIGS. 2A-2B) for distributing the contents of the tanks across an agricultural field.

Spaced agriculture tillage devices such as plow bits 36 and disks 38 may be included along with manure injectors as at 40. The system shown in FIG. 1 is designed to treat 16 spaced crop rows simultaneously, but the system can be designed to treat any convenient number. The sets of wheels 28 are mounted on a tag axle arrangement generally at 42 which enables them to be raised out of contact with the ground when the orthogonally-mounted lateral wheels are to be used during application.

Slurry from the tanks 22 and 24 is fed using a central slurry feed system such as is shown at 50 which is configured to receive slurry from the two spaced slurry tanks using a slurry pump 56 which pumps the slurry through a supply pipe 58 which includes a flow meter 60 and is connected by an elbow to a hose barb 62. A flexible hose (not shown) connects the feed system to the slurry distributor. Such a system is shown and described in above-cross-referenced co-pending application S.N. which is deemed incorporated herein by reference for any purpose.

FIG. 1B is a side elevational view of the embodiment of FIG. 1A with the toolbar and said implements in a raised position for storage or travel. As best seen in the end elevational view of FIG. 1C, the raised agricultural implement combination at 64 adds very little to the overall width of the trailer-mounted system as the implement package generally protrudes less than one foot beyond the corresponding wheels 28. The toolbar and attached implements can be raised and lowered using fluid cylinders, or the like, in a well-known manner.

FIGS. 2A and 2B show reduced side elevational and end views of the liquid manure applicator system of FIG. 1 with a tractor 70 addressing the system. It is important to note that the tractor operator remains very close to the applicator system as it is pulled across a field to apply material to the soil.

In contrast, as shown in the prior art illustration of FIG. 2C, the applicator system 80 must be moved in a direction parallel to the length of the system, both for over the road hauling and during the application operation.

The soil treating aspect 82 is located far from the tractor 84 and furthermore, the view of the operator is obscured or obstructed by the system 80.

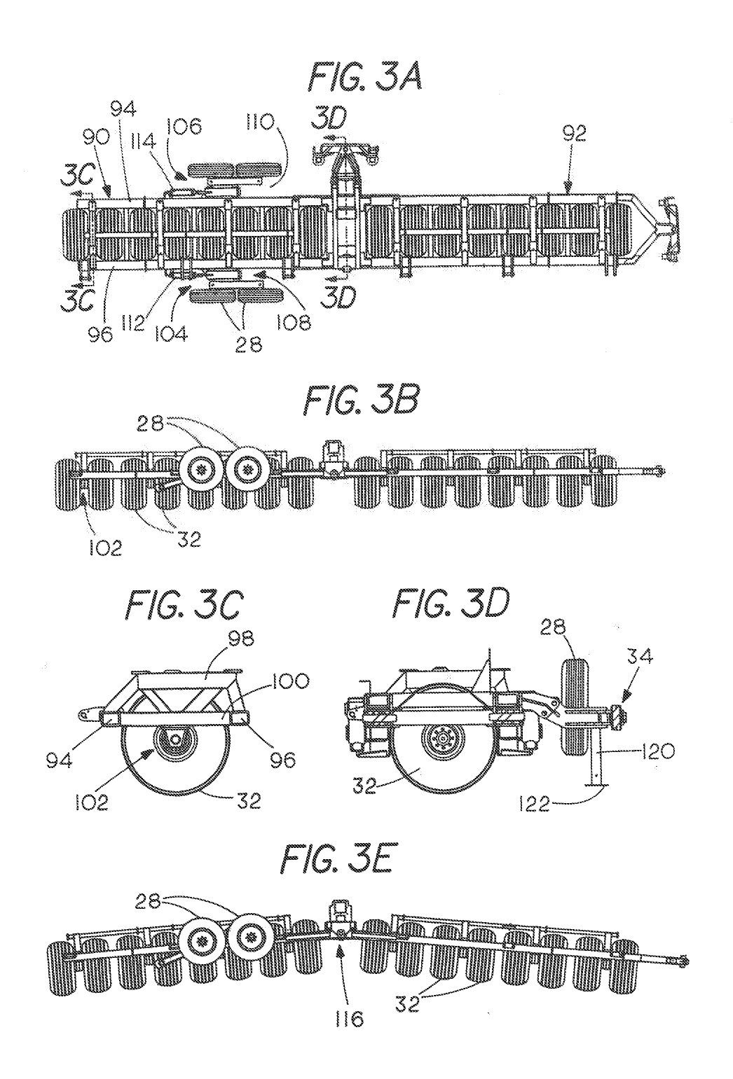

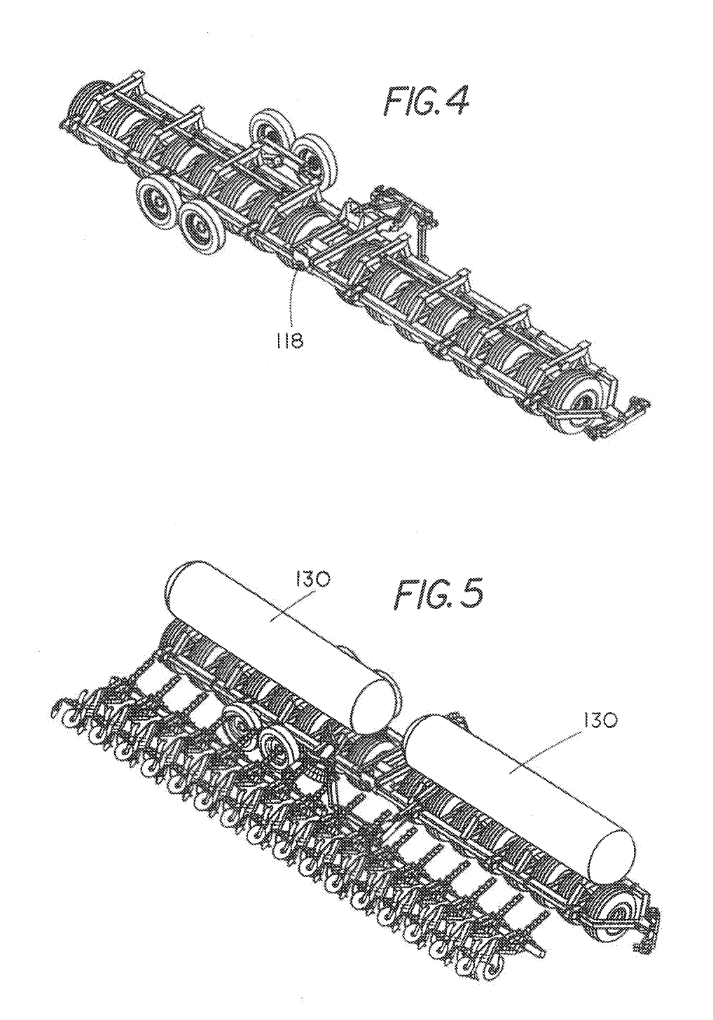

FIGS. 3A-3E and FIG. 4 depict additional details of the carriage support system and chassis frame unit. The chassis 26 includes a pair of spaced opposed frame units 90 and 92, both of which include main stringers as at 94 and 96 and spaced cross-brace members as at 98 and 100. The frame structures are supported from axle arrangements 102 associated with pairs of wheels 32. The frame structures 90 and 92 provide a sturdy support for tanks 22 and 24.

The tag axle arrangements are shown at 104 and 102 and include structural connecting frames 108 and 110 and fluid-operating cylinders 112 and 114 used to deploy and retract the sets of wheels 28.

The spaced opposed frame units 90 and 92 are connected through a central connecting structure 116 and may be pivotally connected to compensate for fields that are not level. FIG. 3E shows both frames in a slightly downward pivoted position. A central axis is shown at 118.

As shown in the figures, the side hitching arrangement 34 is a two-point hitch and includes deployable stabilizing legs 120 with feet 122. Likewise, the end hitch 30 is preferably of a two-point construction.

As shown in FIG. 5, the chassis frame units can be used to support anhydrous ammonia tanks as at 130 and this material may be incorporated into the soil in a manner similar to that used for liquid manure.

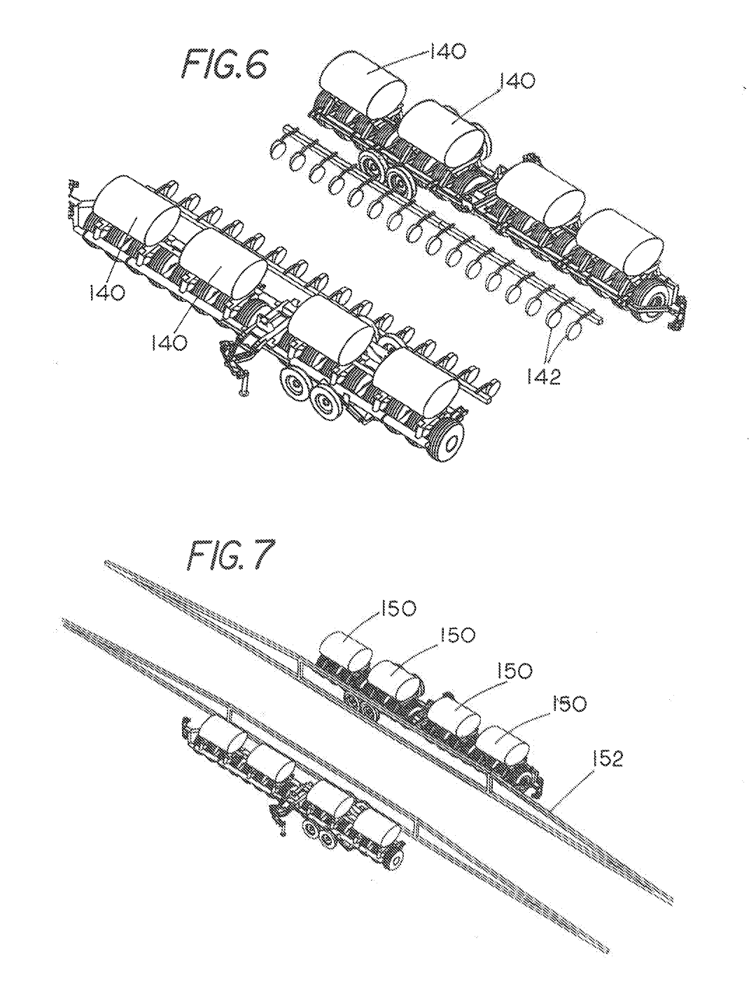

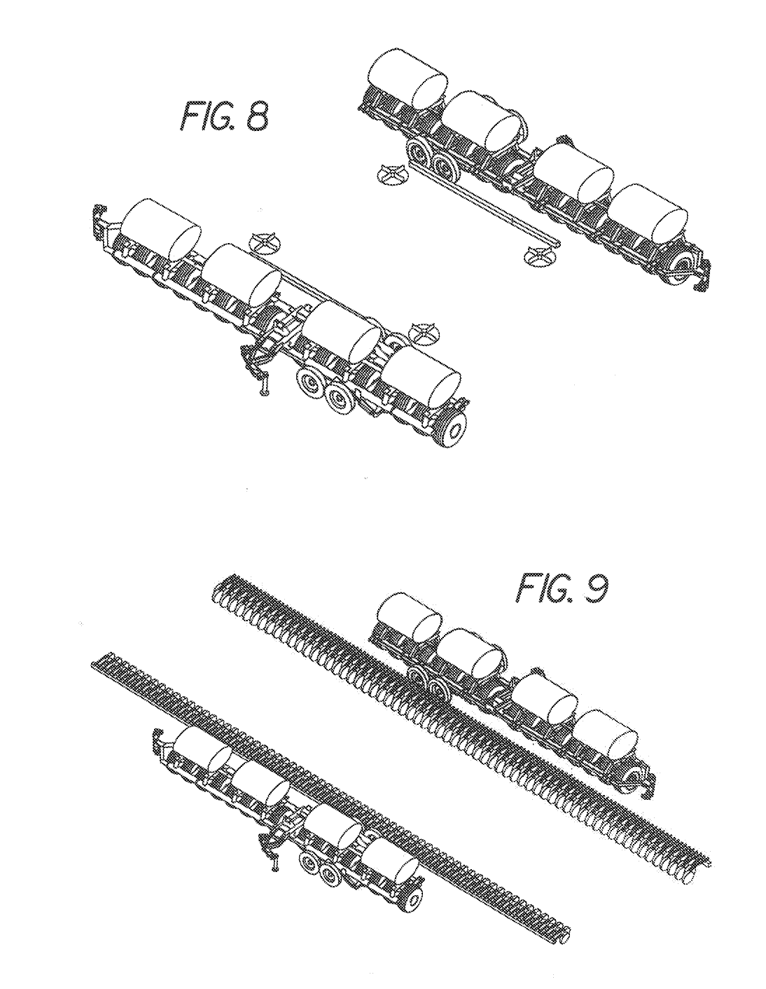

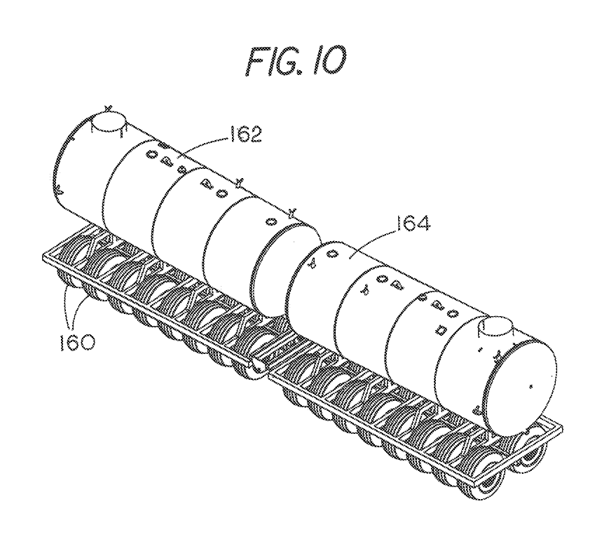

FIG. 6 depicts a carriage system in accordance with the invention used in conjunction with a seed and planting system in which a plurality of seed tanks 140 are used with soil planting devices 142. In FIG. 7, tanks of material to be sprayed 150 are used in combination with a very wide spraying device 152. FIGS. 8 and 9 illustrate still further dry fertilizer and seeding combinations.

FIG. 10 illustrates an embodiment somewhat similar to that shown in FIG. 1 which uses two rows of aligned support wheels 160 to support tanks 162 and 164. Other parts have been removed for clarity.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A liquid manure applicator comprising:
(a) a support carriage arrangement having a length and width and including one or more chassis frame units, said carriage being supported by orthogonally disposed support wheels, including selectively deployable wheels, to enable the carriage to move optionally parallel to the length or the width thereof;
(b) one or more spaced tanks, each tank mounted on one of said chassis frame units, said tanks being in fluid communication with a fluid distribution system;
(c) a plurality of liquid manure incorporation tools spaced along the length of said one or more chassis frame units and directed generally at right angles thereto, said incorporation tools being connected to receive liquid manure from said one or more tanks; and
(d) hitch devices attached to said carriage such that said applicator can be moved in a lengthwise direction for transporting to a place of application and moved laterally parallel to the width thereof for application operations.

2. An applicator as in claim 1 wherein said carriage arrangement comprises a pair of opposed, pivotally connected chassis frame units.

3. An applicator as in claim 2 further comprising a tank mounted on each of said chassis frame units.

4. An applicator as in claim 2 wherein said carriage arrangement further comprises a side hitch mounted between said chassis frame units.

5. An applicator as in claim 3 wherein said carriage arrangement further comprises a side hitch mounted between said chassis frame units.

6. An applicator as in claim 1 further comprising a hitch attached to one end of said carriage arrangement.

7. An applicator as in claim 5 further comprising a hitch attached to one end of said carriage arrangement.

8. An applicator as in claim 1 wherein said one or more chassis frame units further comprise a plurality of equally spaced, parallel lateral support wheels along the length thereof and parallel to the width thereof for carrying said applicator parallel to the width thereof.

9. An applicator as in claim 2 wherein said one or more chassis frame units further comprise a plurality of equally spaced, parallel lateral support wheels along the length thereof and parallel to the width thereof for carrying said applicator parallel to the width thereof.

10. An applicator as in claim 8 wherein said lateral support wheels are arranged in a plurality of rows.

11. An applicator as in claim 1 further comprising a pair of axles carrying wheels to support said carriage for moving it in said lengthwise direction for transporting said applicator to a place of application.

12. An applicator as in claim 1 wherein said selectively deployable wheels are mounted on tag axles.

13. An applicator as in claim 11 wherein said pair of axles are mounted on tag axles.

14. An applicator as in claim 9 further comprising a pair of tag axles carrying wheels to support said carriage for moving it lengthwise for transporting said applicator to a place of application.

15. A liquid manure application system comprising:
(a) a support carriage arrangement including a pair of opposed pivotally connected chassis frame units, each said chassis frame unit being carried by a plurality of aligned, equally spaced, lateral support wheels along the length thereof and parallel to the width thereof for carrying said carriage arrangement in a direction parallel to the width thereof, a pair of tag axles carrying wheels to optionally support said carriage for moving lengthwise for transporting said applicator to a place of application;
(b) a tank mounted on each one of said chassis frame units, each said tank being in fluid communication with a fluid distribution system;
(c) a plurality of incorporation tools spaced along the length of said one or more chassis frames and directed generally at right angles thereto, said incorporation tools being connected to receive and apply liquid from said tanks; and
(d) a pair of hitches for towing said applicator system including a side hitch mounted between said chassis frame units and an end hitch attached to one end of said carriage arrangement.

16. An agricultural applicator system comprising:
(a) a support carriage arrangement including a frame unit having a length and a width;
(b) a plurality of spaced parallel, laterally directed support wheels associated with said frame unit aligned with the width thereof;
(c) a plurality of spaced, deployable support axles including wheels aligned in a direction parallel to the length of said support carriage for optionally supporting said carriage arrangement for movement in a direction parallel to the length thereof;
(d) a plurality of storage containers mounted on said frame unit for containing material to be applied to an agricultural field; and
(e) an application system including one or more devices for applying material to an agricultural field and a distribution device connected between said one or more applicator devices and said storage containers.
